(19) United States
(12) Patent Application Publication
(10) Pub. No.: US 2006/0090297 A1
(43) Pub. Date: May 4, 2006

(54) Hinge capable of being installed to interior or exterior of doorplate

(76) Inventor: Weng Sheng Chue, Taipei (TW)

Correspondence Address: Weng Sheng CHUE, 235 Chung-Ho Box 8-24, Taipei, TW

(21) Appl. No.: 10/978,091

(22) Filed: Nov. 1, 2004

(51) Int. Cl. E05F 1/02

(52) U.S. Cl. 16/312

(57) ABSTRACT

A hinge comprises an upper blade; a receiving portion installed at one lateral side of the upper blade; the receiving portion having an opening facing downwards; an interior of the receiving portion having a stepped hole; the receiving portion being at the same level as the upper blade; a first assembly block installed at another lateral side of the upper blade; a lower blade; a positioning portion located at one lateral side of the lower blade; the positioning portion having an opening facing upwards; an inner wall of the positioning portion being installed with annular teeth; the positioning portion being at the same level as the lower blade; a second assembly block being at another lateral side of the lower blade; a supporting pivotal shaft having an upper sliding inclined surface and a positioning teeth portion. The hinge can be installed at the interior or exterior of a doorplate.

### FIELD OF THE INVENTION

The present invention relates to hinges, and particularly to a hinge which can be installed at the interior or exterior of a doorplate.

### BACKGROUND OF THE INVENTION

In general, hinge is installed to the connection of a doorplate and a doorframe so that the doorplate is rotatable respective the doorframe.

Referring to FIGS. 7 and 8, the convention hinge includes an upper blade 50, a lower blade 60 and a supporting pivotal shaft 70. One side of the upper blade 50 is installed with a receiving portion 51 facing downwards. One side of the lower blade 60 is installed a positioning portion 61 facing upwards. The inner wall of the positioning portion 61 is; with an annular teeth structure. An upper outer side of the supporting pivotal shaft 70 is installed with a sliding inclined surface 71 with respective to the upper blade 50 and a positioning teeth portion 72 with respect to the positioning portion 61 of the lower blade 60.

In assembly of the hinge, the upper section of the supporting pivotal shaft 70 is inserted into the receiving portion 51 of the upper blade 50 and the lower section thereof is inserted into the positioning portion 61 of the lower blade 60. The upper blade 50 is assembled to the doorplate 75 and the lower blade 60 is assembled to the doorframe 76.

In operation, the opening of the doorplate 75 will drive the upper blade 50 to rotate with respect to the supporting pivotal shaft 70. Since the lower section of the supporting pivotal shaft 70 is engaged to the lower blade 60, the inclined surface of the receiving portion 51 of the upper blade 50 is shifted from the sliding inclined surface 71 of the supporting pivotal shaft 70. When no force is applied to the doorplate 75, the receiving portion 51 of the upper blade 50 will restore to the original position (close state) along the sliding inclined surface 71 of the supporting pivotal shaft 70 due to the weight of the doorplate 75. Thereby the doorplate 75 is closed automatically.

However when the hinge is assembled unidirectionally, namely, if the upper blade 50 is at the right side, the doorplate is at the right side. On the contrary, when the upper blade 50 is at the left side, the doorplate is also at left side. Otherwise, the hinge cannot be assembled. Thereby the user of the hinge is inconvenient.

### SUMMARY OF THE INVENTION

Accordingly, the primary object of the present invention is to provide a hinge which can be installed at the interior or exterior of a doorplate.

To achieve above objects, the present invention provides a hinge. The hinge has the following elements.

An upper blade is included.

A receiving portion is installed at one lateral side. The receiving portion has an opening facing downwards. An interior of the receiving portion has a stepped hole. After assembly, the receiving portion is at the same level as the upper blade.

A first assembly block is installed at another lateral side of the upper blade.

A lower blade is included.

A positioning portion is at one lateral side of the lower blade. The positioning portion has an opening facing upwards. An inner wall of the positioning portion is installed with annular teeth. After assembly, the positioning portion is at the same level as the lower blade.

A second assembly block is at another lateral side of the lower blade.

A supporting pivotal shaft has an upper sliding inclined surface corresponding to the stepped hole of the upper blade and a positioning teeth portion corresponding to the positioning portion of the lower blade. The sliding inclined surface and the positioning teeth portion are formed as a stepped structure.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is an exploded perspective view of the present invention.

FIG. 3 is an exploded perspective view showing the use of the present invention.

FIG. 4 is a cross sectional view about the use of the present invention.

FIG. 5 is an exploded perspective view showing another application of the present invention.

FIG. 6 is a cross sectional view showing another use of the present invention.

FIG. 7 is an exploded perspective view of a prior art.

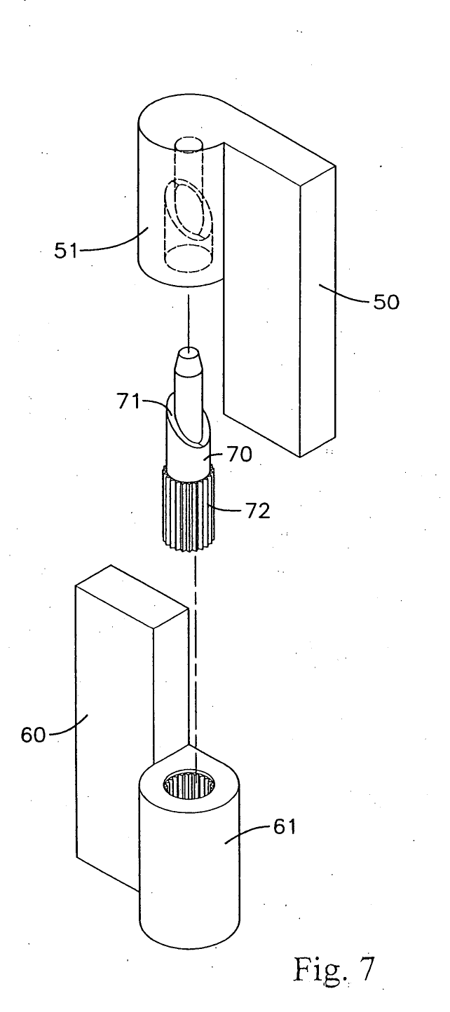

FIG. 8 is a cross section view of the prior art.

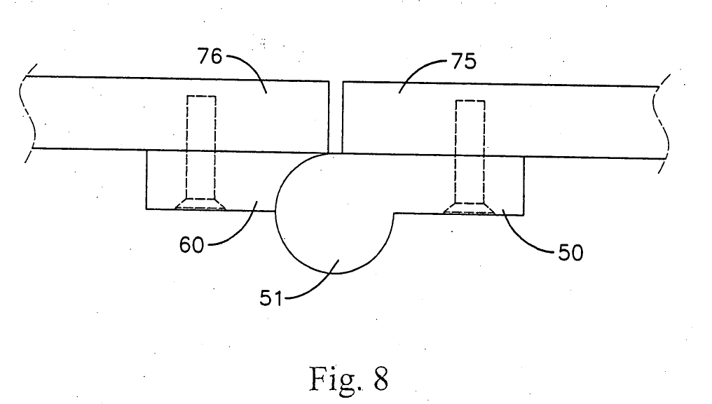

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

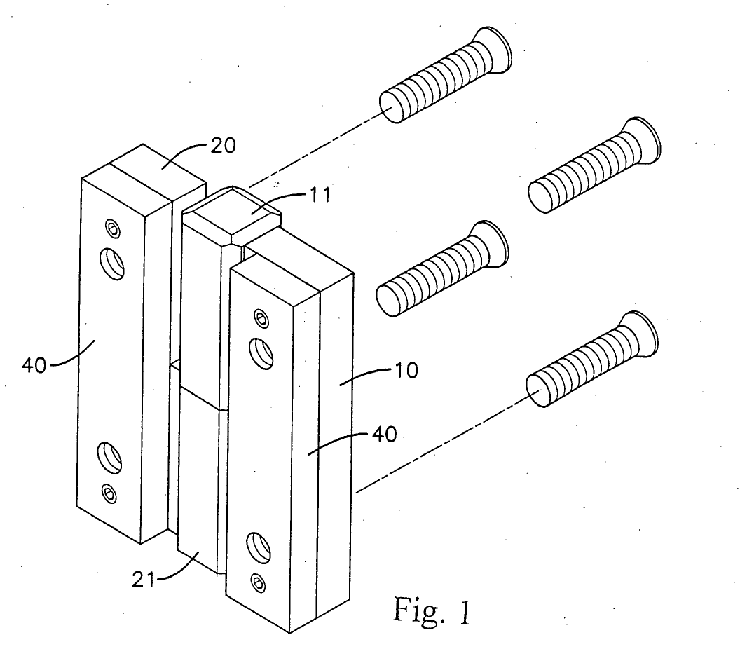

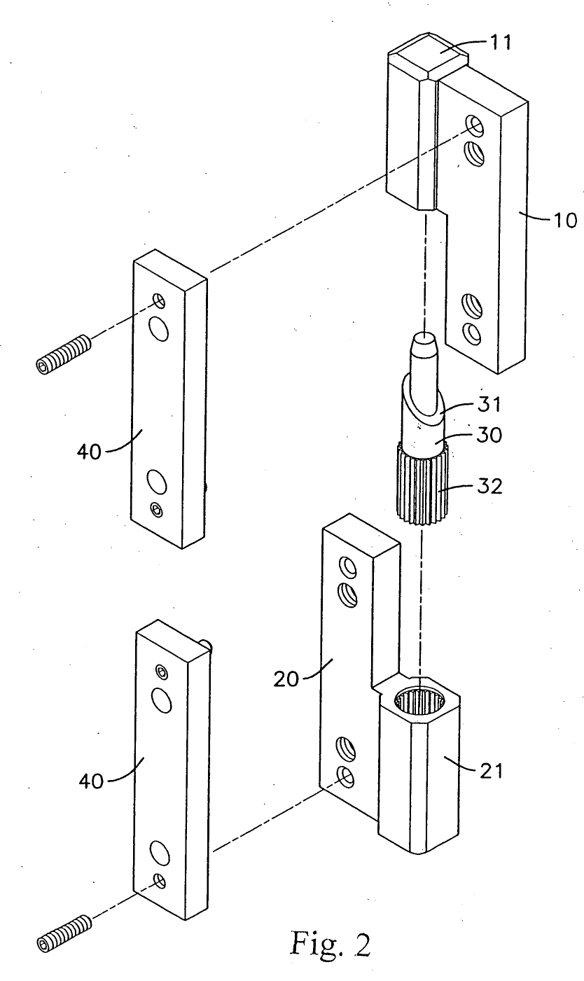

With reference to FIGS. 1 to 2, the hinge of the present invention is illustrated. The hinge has the following elements.

An upper blade 10 is included.

A receiving portion 11 is installed at one lateral side. The receiving portion 11 has an opening facing downwards. An interior of the receiving portion 11 has a stepped hole. After assembly, the receiving portion 11 is at the same level as the upper blade 10.

A first assembly block 40 is installed at another lateral side of the upper blade 10.

A lower blade 20 is included.

A positioning portion 21 is at one lateral side of the lower blade 20.

The positioning portion 21 has an opening facing upwards. An inner wall of the positioning portion 21 is installed with annular teeth. After assembly, the positioning portion 21 is at the same level as the lower blade 20.

A second assembly block 40 is at another lateral side of the lower blade 20.

A supporting pivotal shaft 30 has an upper sliding inclined surface 31 corresponding to the stepped hole of the upper blade 10 and a positioning teeth portion 32 corresponding to the positioning portion 21 of the lower blade 20. The sliding inclined surface 31 and the positioning teeth portion 32 are formed as a stepped structure.

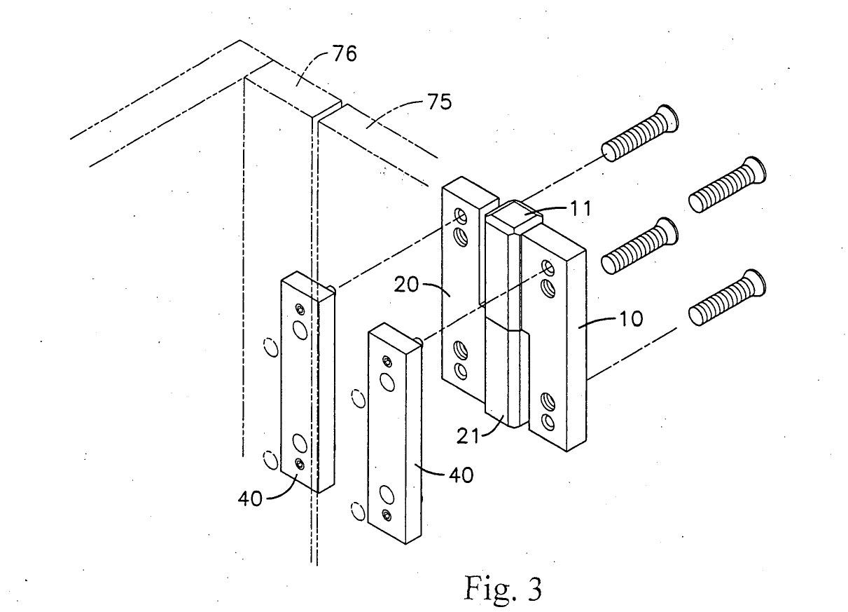

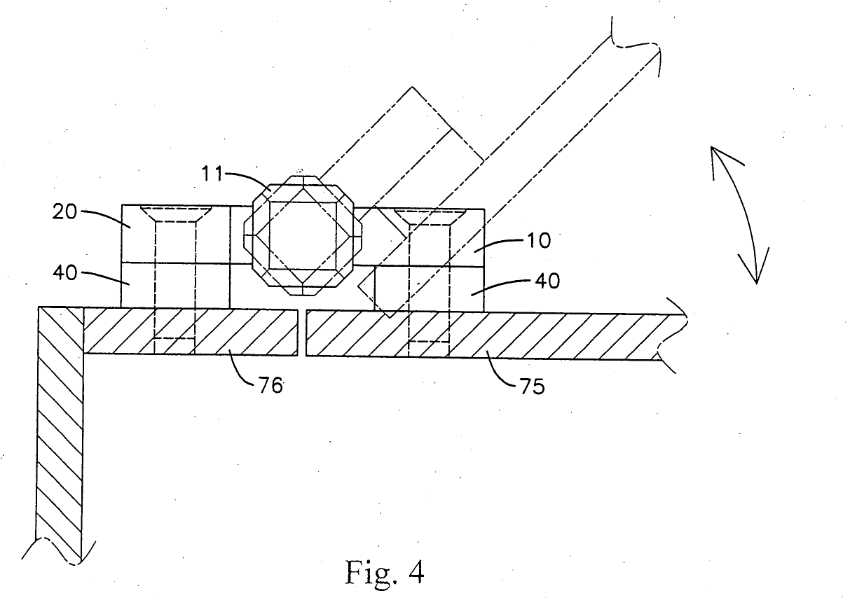

Referring to FIGS. 2 to 4, one application of the present invention is illustrated. It is illustrated that the present invention is applied to an outer side of a doorplate 75. The first assembly blocks 40 is assembled to the doorplate 75 directly and the upper blade 10 is assembled upon the first assembly block 40. The second assembly block 40 is assembled at the outer side of the doorframe 76 and the lower blade 20 is assembled upon the outer side of the assembly block 40. Thereby the hinge of the present invention can be assembled simply to the outer side of the doorplate 75 so as to be as a hinge which makes the door capable of being opened from the outer side.

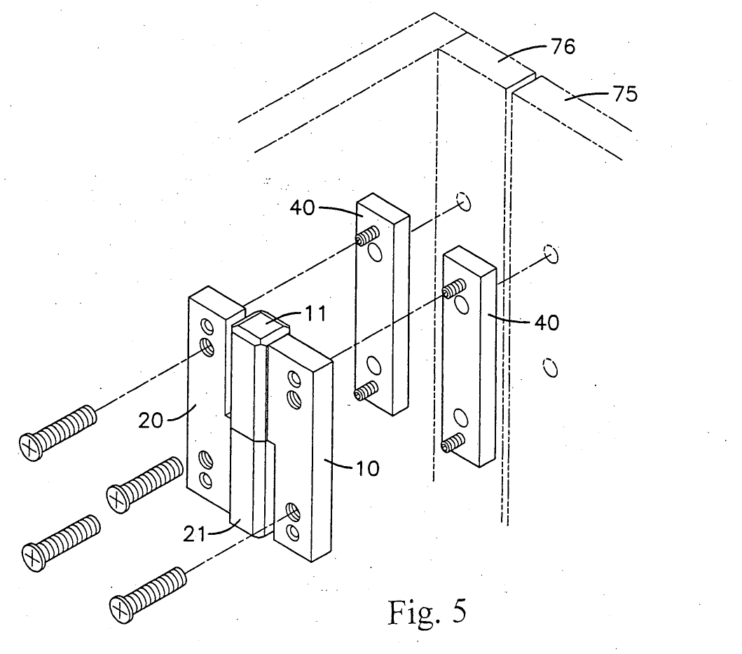

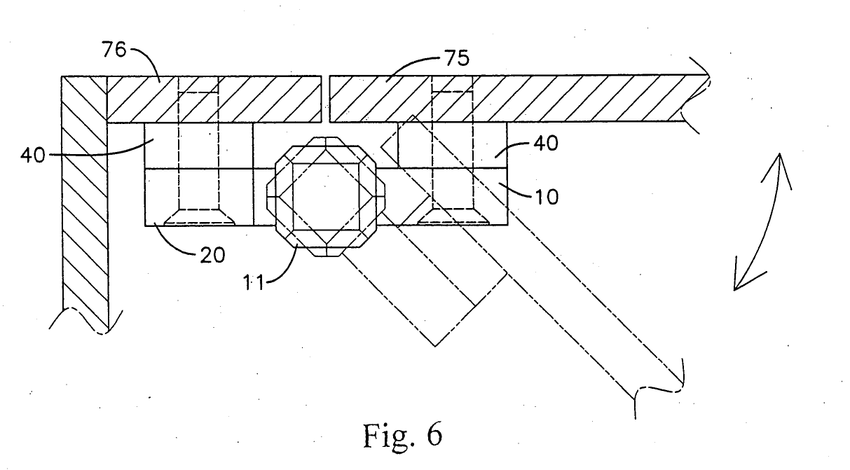

With reference to FIGS. 2, 5 and 6, when the present invention is desired to be assembled to the inner side of the doorplate 75, the first assembly block 40 is assembled between the inner side of the doorplate 75 and the upper blade 10 and the second assembly block 40 is assembled between the inner side of the doorframe 76 and the lower blade 20. Thereby the hinge of the present invention can be used to the inner side of the doorplate 75 so as to be as a hinge which makes the door capable of being opened from the inner side.

Since in the present invention, the receiving portion 11 of the upper blade 10 is installed at the same level of the upper blade 10 and the positioning portion 21 of the lower blade 20 is at the same level as the lower blade 20. Thereby the upper blade 10 is rotatable outwards or inwards with respect to the lower blade 20. With the first and second assembly blocks 40 at the same sides of the upper blade 10 and lower blade 20, respectively, the present invention can be assembled to different sides of the doorplate or doorframe. The orientation is not confined so that the hinge can be installed at two sides.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A hinge comprising:
an upper blade;
a receiving portion installed at one lateral side of the upper blade; the receiving portion having an opening facing downwards; an interior of the receiving portion having a stepped hole; the receiving portion being at the same level as the upper blade;
a first assembly block installed at another lateral side of the upper blade;
a lower blade;
a positioning portion located at one lateral side of the lower blade; the positioning portion having an opening facing upwards; an inner wall of the positioning portion being installed with annular teeth; the positioning portion being at the same level as the lower blade;
a second assembly block being at another lateral side of the lower blade;
a supporting pivotal shaft having an upper sliding inclined surface corresponding to the stepped hole of the upper blade and a positioning teeth portion corresponding to the positioning portion of the lower blade; the sliding inclined surface and the positioning teeth portion being formed as a stepped structure.
